(19) United States
(12) Patent Application Publication
(10) Pub. No.: US 2026/0281063 A1
(43) Pub. Date: Sep. 17, 2026

(54) METHOD AND DEVICE FOR LINKING EVENT MESSAGES OR DELIVERY INFORMATION MESSAGES WITH BEAUTY COUNSELOR CHATBOT SERVICE

(71) Applicant: Amorepacific Corporation, Seoul (KR)

(72) Inventors: Donghyeon KIM, Seoul (KR); Chikook NO, Seoul (KR); Pilbong Jang, Seoul (KR); Dasom Go, Seoul (KR); Jiwoo Kim, Seoul (KR); Eunsang Cho, Seoul (KR); Hojae Han, Seoul (KR)

(73) Assignee: Amorepacific Corporation, Seoul (KR)

(21) Appl. No.: 19/299,488

(22) Filed: Aug. 14, 2025

(30) Foreign Application Priority Data
Mar. 13, 2025 (KR) 10-2025-0032684

(51) Int. Cl. H04L 51/02; G06Q 30/02; G06Q 30/0601; G06F 3/0484

(52) U.S. Cl. CPC H04L 51/02; G06Q 30/0281; G06Q 30/0631; G06F 3/0484

(57) ABSTRACT

Disclosed is a method and device for linking an event message or a delivery information message to a beauty counselor chatbot service that may receive a user request through an external channel to which an event message or a delivery information message of a beauty shopping mall is exposed, may execute a conversation screen with an artificial intelligence (AI) chatbot for a beauty counselor chatbot service in response to the user request, and may provide information related to a message corresponding to a user access path through the conversation screen.

### CROSS-REFERENCE TO RELATED APPLICATIONS

This application claims the priority benefit of Korean Patent Application No. 10-2025-0032684, filed on Mar. 13, 2025, in the Korean Intellectual Property Office, the disclosure of which is incorporated herein by reference.

### BACKGROUND

### 1. Field of the Invention

Example embodiments of the following description relate to technology for providing an artificial intelligence (AI)-based beauty counselor chatbot service.

### 2. Description of the Related Art

With the development of the Internet and information technology (IT) devices, counseling may be performed online beyond the offline realm, and services are proposed that connect professional counselors and provide counseling through the web, mobile apps, and the like.

In general, to resolve inquiries related to products and services of a specific company online, a user needs to complete an online membership sign-up procedure through a homepage of the company and to register an inquiry through log-in. When a counselor receives an inquiry of a customer, searches for related counseling knowledge using an internal counseling knowledge database, and posts an answer based on this, the customer needs to log in to a corresponding site and to check the answer.

Alternatively, an automatic responder may be used to provide automated voice guidance to a customer, or a counselor may be connected over a phone to provide the customer with a sophisticated and detailed counseling service.

For example, technology that may provide an efficient counseling service through a counseling transfer between a chatbot and a counselor matched to each other by counseling category to provide a 24-hour counseling service is disclosed in Korean Patent Laid-Open Publication No. 10-2020-0063282 (published on June 5, 2020).

### SUMMARY

Example embodiments may link an event message or a delivery information message to an artificial intelligence (AI)-based beauty counselor chatbot service.

According to an example embodiment, there is provided a chatbot service linkage method of a computer device including at least one processor, the chatbot service linkage method including receiving, by the at least one processor, a user request through an external channel to which an event message or a delivery information message of a beauty shopping mall is exposed; executing, by the at least one processor, a conversation screen with an artificial intelligence (AI) chatbot for a beauty counselor chatbot service in response to the user request; and providing, by the at least one processor, information related to a message corresponding to a user access path through the conversation screen.

According to an aspect, the event message or the delivery information message exposed to the external channel may include a link to access the beauty counselor chatbot service, and in response to a click on the event message or the delivery information message, the click may be recognized as the user request to call the beauty counselor chatbot service.

According to another aspect, the providing may include providing information related to the message through the conversation screen at a point in time of entering the conversation screen.

According to still another aspect, the providing may include providing, to a user who is accessed through the event message, introduction to a corresponding event and personalized recommendation content to the user, through the conversation screen.

According to still another aspect, the providing may include providing, to a user who is accessed through the delivery information message, a delivery status of a product being guided and personalized recommendation content to the user.

According to still another aspect, the chatbot service linkage method may further include providing, by the at least one processor, an answer of the AI chatbot through the beauty counselor chatbot service as search results for a search term of one type among text, image, and voice input from a user in conjunction with a search engine.

According to still another aspect, the chatbot service linkage method may further include activating, by the at least one processor, a button to access the beauty counselor chatbot service for a user who stays on a product details page or promotion page of the beauty shopping mall for a predetermined period of time or more.

According to an example embodiment, there is provided a computer device including at least one processor configured to execute computer-readable instructions, wherein the at least one processor is configured to process a process of receiving a user request through an external channel to which an event message or a delivery information message of a beauty shopping mall is exposed; a process of executing a conversation screen with an artificial intelligence (AI) chatbot for a beauty counselor chatbot service in response to the user request; and a process of providing information related to a message corresponding to a user access path through the conversation screen.

According to some example embodiments, by linking an event message or a delivery information message to an AI-based beauty counselor chatbot service, it is possible to reduce consumer complaints and to improve a product purchase conversion rate through advance-response to a customer service (CS).

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of an internal configuration of a computer device according to an example embodiment;

FIGS. 2 to 4 illustrate examples of a screen of an artificial intelligence (AI) beauty counselor chatbot service;

FIG. 5 is a flowchart illustrating an example of a chatbot service linkage method that may be performed by a computer device according to an example embodiment;

FIG. 6 is a system architecture for a beauty counselor chatbot service according to an example embodiment;

FIG. 7 illustrates an example of a chatbot conversation screen accessed through an event message according to an example embodiment;

FIG. 8 illustrates an example of a chatbot conversation screen accessed through a delivery information message according to an example embodiment; and

FIGS. 9 and 10 illustrate examples of utilizing a beauty counselor chatbot service according to an example embodiment.

### DETAILED DESCRIPTION

Hereinafter, example embodiments will be described with reference to the accompanying drawings.

Example embodiments disclosed herein relate to technology for providing an artificial intelligence (AI)-based beauty counselor chatbot service.

The example embodiments including disclosures herein may link an event message or a delivery information message to an artificial intelligence (AI)-based beauty counselor chatbot service.

A chatbot service linkage device according to the example embodiments may be implemented by at least one computer device, and a chatbot service linkage method according to the example embodiments may be performed through the at least one computer device included in the chatbot service linkage device. Here, a computer program according to an example embodiment may be installed and run on the computer device, and the computer device may perform the chatbot service linkage method according to the example embodiments under control of the running computer program. The aforementioned computer program may be stored in a computer-readable recording medium to computer-implement the chatbot service linkage method in conjunction with the computer device.

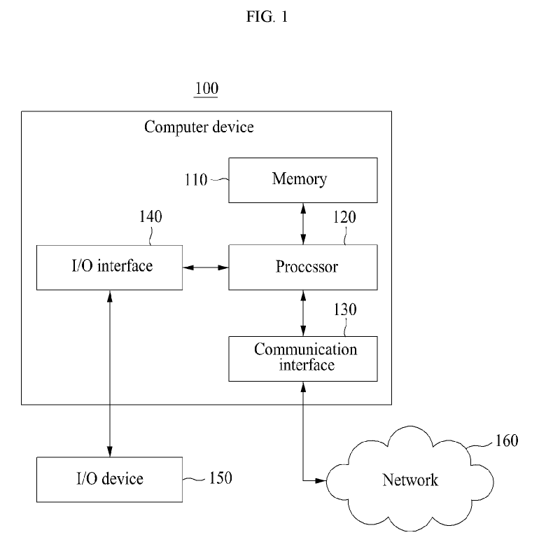

FIG. 1 is a diagram illustrating an example of a computer device according to an example embodiment. For example, a chatbot service linkage device according to example embodiments may be implemented by a computer device 100 shown in FIG. 1.

Referring to FIG. 1, as components to execute a chatbot service linkage method according to example embodiments, the computer device 100 may include a memory 110, a processor 120, a communication interface 130, and an input/output (I/O) interface 140.

The memory 110 may include a permanent mass storage device, such as a random access memory (RAM), a read only memory (ROM), and a disk drive, as a computer-readable recording medium. Here, the permanent mass storage device, such as a ROM and a disk drive, may be included in the computer device 100 as a permanent storage device separate from the memory 110. Also, an operating system (OS) and at least one program code may be stored in the memory 110. Such software components may be loaded to the memory 110 from another computer-readable recording medium separate from the memory 110. The other computer-readable recording medium may include a computer-readable recording medium, for example, a floppy drive, a disk, a tape, a DVD/CD-ROM drive, a memory card, etc. According to other example embodiments, software components may be loaded to the memory 110 through the communication interface 130, instead of the computer-readable recording medium. For example, the software components may be loaded to the memory 110 of the computer device 100 based on a computer program installed by files received over a network 160.

The processor 120 may be configured to process instructions of a computer program by performing basic arithmetic operations, logic operations, and I/O operations. The computer-readable instructions may be provided by the memory 110 or the communication interface 130 to the processor 120. For example, the processor 120 may be configured to execute received instructions in response to a program code stored in a storage device, such as the memory 110.

The communication interface 130 may provide a function for communication between the communication device 100 and another apparatus. For example, the processor 120 of the computer device 100 may forward a request or an instruction created based on a program code stored in the storage device such as the memory 110, data, and a file, to other apparatuses over the network 160 under control of the communication interface 130. Inversely, a signal, an instruction, data, a file, etc., from another apparatus may be received at the computer device 100 through the communication interface 130 of the computer device 100. For example, a signal, an instruction, data, etc., received through the communication interface 130 may be forwarded to the processor 120 or the memory 110, and a file, etc., may be stored in a storage medium, for example, the permanent storage device, further includable in the computer device 100.

The communication scheme is not limited and may include a near field wireless communication scheme between devices as well as a communication scheme using a communication network (e.g., mobile communication network, wired Internet, wireless Internet, and broadcasting network) includable in the network 160. For example, the network 160 may include at least one network among networks that include a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, a tree or hierarchical network, and the like. However, they are provided as examples only.

The I/O interface 140 may be a device used for interfacing with an I/O device 150. For example, an input device may include a device, such as a microphone, a keyboard, a mouse, etc., and an output device may include a device, such as a display, a speaker, etc. As another example, the I/O interface 140 may be a device for interfacing with an apparatus in which an input function and an output function are integrated into a single function, such as a touchscreen. The I/O device 150 may be configured as a single apparatus with the computer device 100.

Also, according to other example embodiments, the computer device 100 may include a greater or smaller number of components than the number of components of FIG. 1. However, there is no need to clearly illustrate many conventional components. For example, the computer device 100 may be configured to include at least a portion of the I/O device 150 or may further include other components, such as a transceiver, a camera, various types of sensors, and a database.

Hereinafter, example embodiments of a method and device for linking an event message or a delivery information message to a beauty counselor chatbot service are further described.

The example embodiments relate to a chatbot service that is linked to an event message or a delivery information message, and may provide a conversation environment linked to information of a corresponding message to a user who clicks on the event message or the delivery information message.

The computer device 100 according to the example embodiment may provide an AI beauty counselor chatbot service to a client through connection to a dedicated application installed on the client or a website/mobile site related to the computer device 100. A computer-implemented chatbot service linkage device may be configured in the computer device 100. For example, the chatbot service linkage device may be implemented in a form of a program that independently operates, or may be configured in an in-app form of a specific application (e.g., beauty shopping mall) to be operable on the specific application. For example, the AI beauty counselor chatbot service refers to a personalized counseling service using an AI chatbot, which may be provided as a sub-service of an online beauty shopping mall.

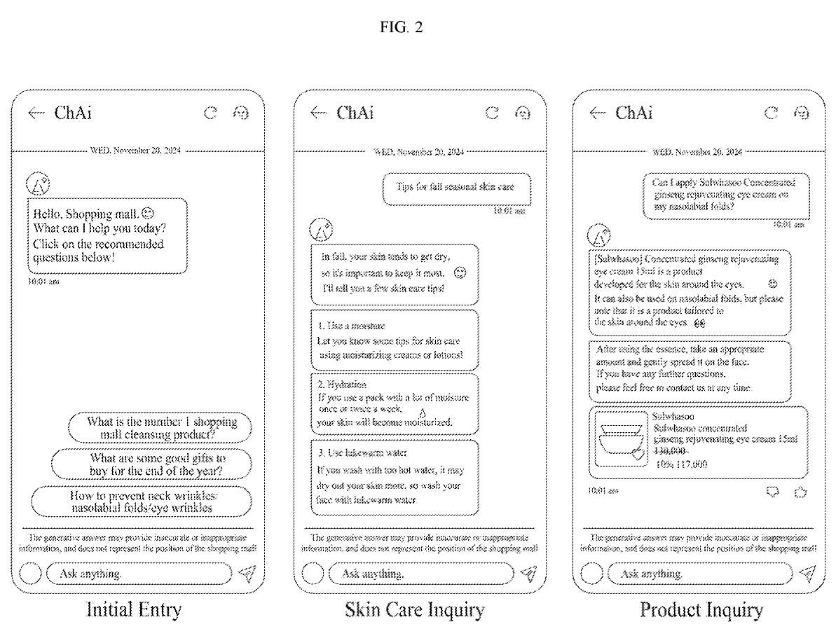

FIGS. 2-4 illustrate examples of a screen of an AI beauty counselor chatbot service.

The computer device 100 may provide a beauty counselor chatbot service using an AI chatbot.

The beauty counselor chatbot service may provide a personalized service for product recommendation and delivery tracking as well as counseling on the skin based on conversation with an AI chatbot.

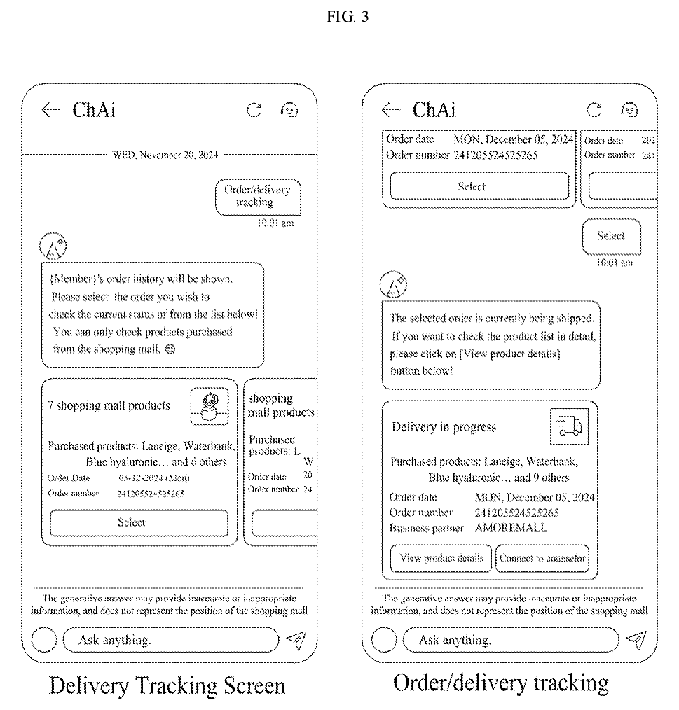

Referring to FIGS. 2 and 3, the beauty counselor chatbot service may provide skin care inquiry, product inquiry, delivery tracking, delivery status check, and the like as well as an initial entry screen that provides a guide button as a conversation screen with the AI chatbot.

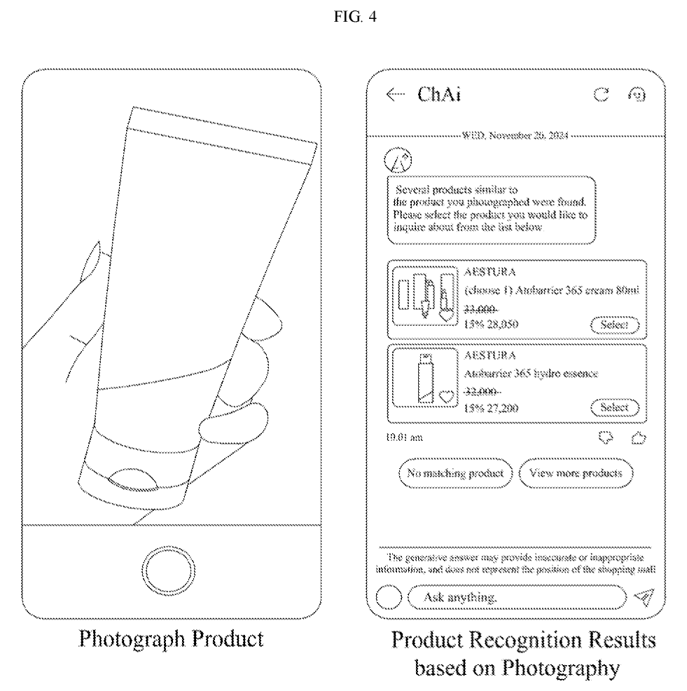

In addition, as shown in FIG. 4, a search function of providing product recognition results based on product capturing may also be provided.

The example embodiment may provide the beauty counselor chatbot service that reflects the user's personal unique data and professional data for beauty solution.

The processor 120 of the computer device 100 may be implemented as a component for performing the following chatbot service linkage method. Depending on example embodiments, the components of the processor 120 may be selectively included in or excluded from the processor 120. Also, depending on example embodiments, the components of the processor 120 may be separated or merged for functional representation of the processor 120.

The processor 120 and the components of the processor 120 may control the computer device 100 to perform operations included in the following chatbot service linkage method. For example, the processor 120 and the components of the processor 120 may be implemented to execute a code of an OS included in the memory 110 and an instruction according to a code of at least one program.

Here, the components of the processor 120 may be representations of different functions performed by the processor 120 in response to a command provided from a program code stored in the computer device 100.

The processor 120 may read a necessary instruction from the memory 110 to which instructions related to control of the computer device 100 are loaded. In this case, the read instruction may include an instruction for controlling the processor 120 to perform operations described below.

The operations included in the chatbot service linkage method described below may be performed in order different from illustrated order, and some of the operations may be omitted or an additional process may be further included.

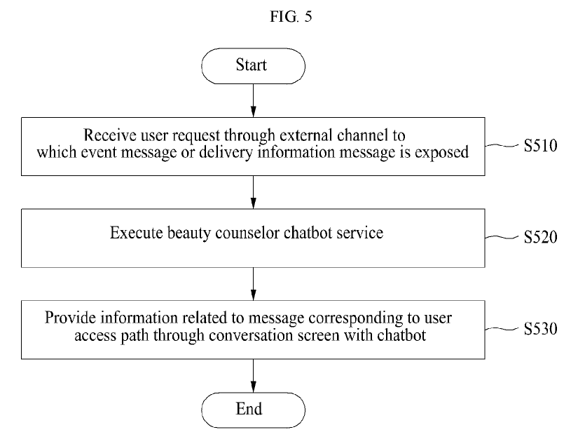

FIG. 5 is a flowchart illustrating an example of a chatbot service linkage method that may be performed by a computer device according to an example embodiment.

Referring to FIG. 5, in operation S510, the processor 120 may receive a user request for a beauty counselor chatbot service through an external channel to which an event message or a delivery information message of an online beauty shopping mall is exposed. The event message or the delivery information message of the online beauty shopping mall may be expressed through various external channels, such as various types of social network services, portable services, and text services, and the event message or the delivery information message exposed through the external channel may include a link to access the beauty counselor chatbot service. In response to a click on the event message or the delivery information message exposed through the external channel, the processor 120 may recognize this click as the user request to call the beauty counselor chatbot service. Here, the user request may include an identifier of a message (event message or delivery information message) that is a source of a user access path.

In operation S520, in response to receiving the user request through the event message or the delivery information message, the processor 120 may execute the beauty counselor chatbot service. Through a conversation session generated between the AI chatbot and a user, the processor 120 may provide the beauty counselor chatbot service. The example embodiment may provide the beauty counselor chatbot service through a chat channel separate from the external channel, without providing a chatbot service within the external channel to which the event message or the delivery information message is exposed.

In operation S530, in response to entry into the conversation screen with the chatbot according to the beauty counselor chatbot service, the processor 120 may preferentially provide information related to a message corresponding to the user's access path through the conversation screen. Here, when the user clicks on the event message and enters the conversation screen with the chatbot, basic introduction to a corresponding event (or promotion) may be initially provided. Also, when the user clicks on the delivery information message and enters the conversation screen with the chatbot, a delivery status of a product being guided may be initially provided.

Further, the processor 120 may provide personalized recommendation content based on conversation with the AI chatbot through the beauty counselor chatbot service. The processor 120 may provide, to a user who is accessed through the event message, basic introduction to the event and a conversation environment that allows an answer to a specific question related to the event, and may recommend a personalized special benefit or a promotion specific to a brand preferred by the user. The processor 120 may proactively respond to consumer complaints by verifying a delivery status and may provide other products that are good to use with a product of which delivery is guided or beauty information as recommendation content for a user who is accessed through the delivery information message.

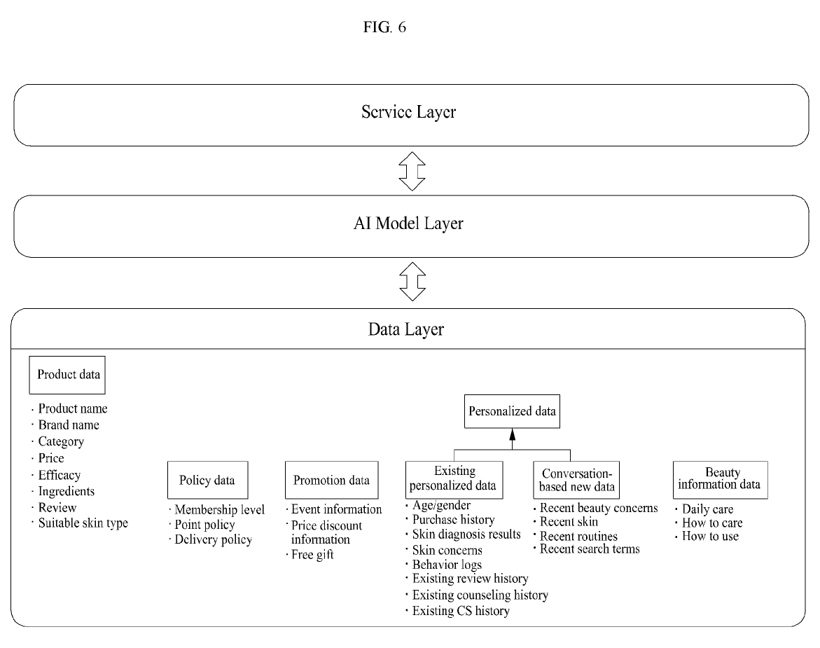

FIG. 6 is a system architecture for a beauty counselor chatbot service according to an example embodiment.

Referring to FIG. 6, a system for the beauty counselor chatbot service may include service layers (e.g., customer center, customer relationship management (CRM) text transmission, chat channel, pop-up store, etc.) of the overall online beauty shopping mall, an AI model layer, and a data layer.

The data layer may include all data for the service, for example, product data, policy data, promotion data, personalized data, and beauty information data.

In the example embodiment, personalized data for each user may be classified into conversation-based new data managed in the form of short-term memory data and the existing personalized data managed in the form of long-term memory data.

The short-term memory data may include recent beauty interests, recent skin concerns, recent routines, recent search terms, and the like, and the long-term memory data may include age, gender, purchase history, skin diagnosis results, skin concerns, behavior logs, existing review history, existing counseling history, existing CS history, and the like.

The processor 120 may reflect the personalized data for a user who is accessed through an event message or a delivery information message, and may provide recommendation content optimized for the user.

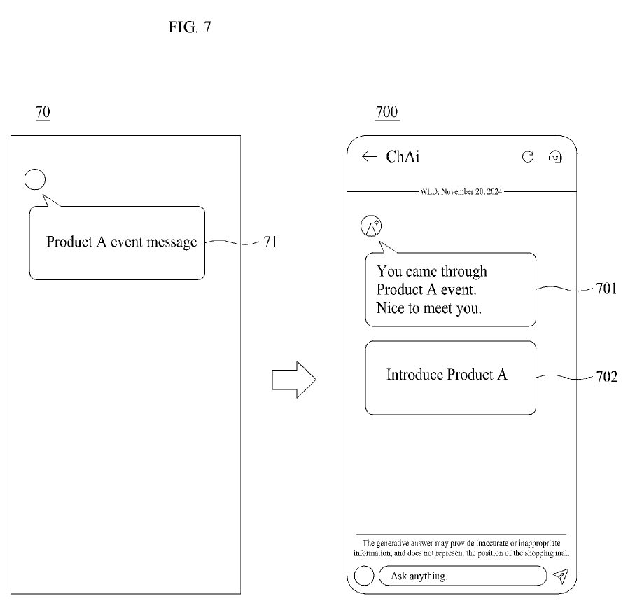

FIG. 7 illustrates an example of a chatbot conversation screen accessed through an event message according to an example embodiment.

Referring to FIG. 7, an event message 71 of an online beauty shopping mall may be exposed through a service screen 70 of various external channels, such as various types of social network services, portal services, and text services.

When a user clicks on the event message 71, an AI beauty counselor chatbot service of the online beauty shopping mall may be executed and the user may enter a conversation screen 700 with an AI chatbot.

Here, the AI chatbot may recognize that a source of a path through which the user is accessed is the event message 71 and accordingly, may provide information (701, 702) related to a corresponding event through the conversation screen 700.

The AI chatbot may preferentially provide a greeting message 701 and basic introduction 701 related to the event to the user who is accessed through the event message 71. Depending on the event content, the greeting message 701 and the basic introduction 702 provided immediately after entering the conversation screen 700 may be differently configured.

When the event message 71 is the event content for product A, a greeting through a product A event and introduction to product A may be provided immediately upon entry into the conversation screen 700 with the AI chatbot.

The AI chatbot may provide an answer to a user question through the conversation screen 700, and, particularly, may recommend a promotion or a benefit of a brand the user usually prefers based on personalized data of the user.

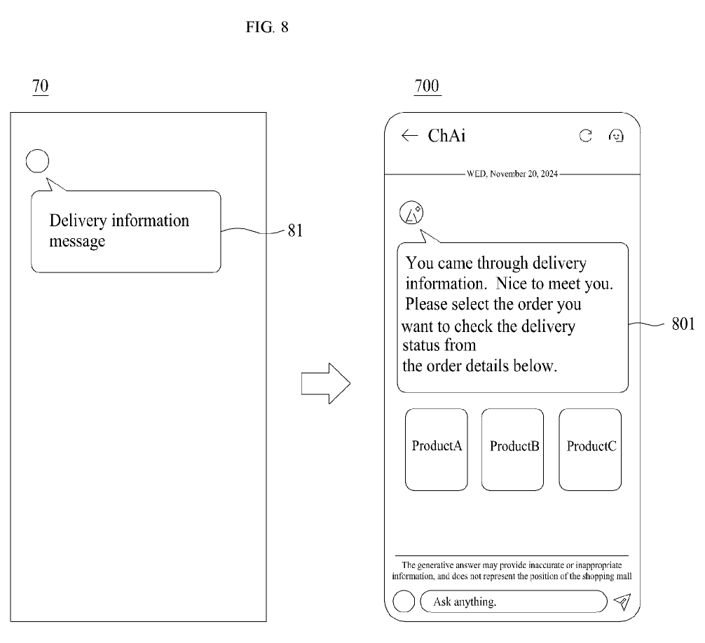

FIG. 8 illustrates an example of a chatbot conversation screen accessed through a delivery information message according to an example embodiment.

Referring to FIG. 8, a delivery information message 81 related to a product ordered by the user in the online beauty shopping mall may be exposed through the service screen 70 of various external channels, such as various types of social network services, portal services, and text services.

When the user clicks on the delivery information message 81, the AI beauty counselor chatbot service of the online beauty shopping mall may be executed and the user may enter the conversation screen 700 with the AI chatbot.

Here, the AI chatbot may recognize that a source of a path through which the user is accessed is the delivery information message 81 and accordingly, may provide a delivery status 801 of a product being guided through the conversation screen 700.

The AI chatbot may preferentially provide a greeting message and the delivery status 801 of the product being guided to the user who is accessed through the delivery information message 81. According to the product being guided in the delivery information message 81, the message content provided immediately after entering the conversation screen 700 may be differently configured.

When the delivery information message 81 is delivery information on product A, a confirmation message on a delivery status of product A may be provided immediately upon entering the conversation screen 700 with the AI chatbot.

The AI chatbot may provide an answer to a user question through the conversation screen 700, and may recommend beauty information related to product A or other products based on personalized data of the user. Here, the AI chatbot may provide beauty information or product recommendation optimized for the user by considering the user's skin type or recent skin concerns and interests.

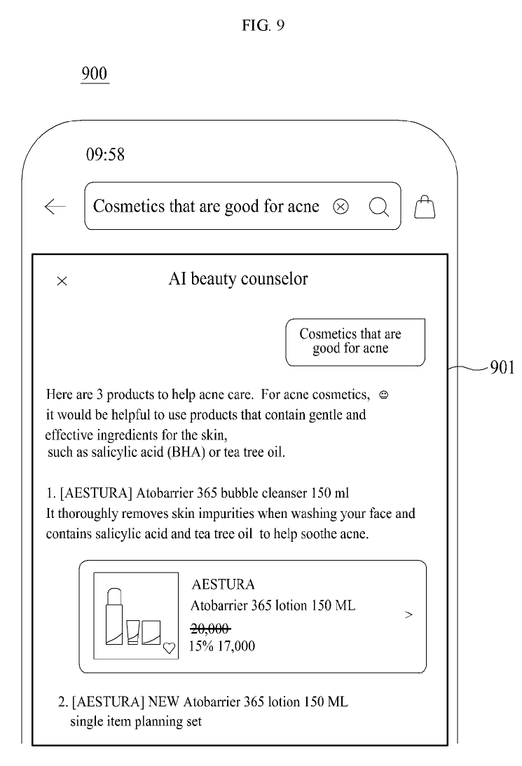

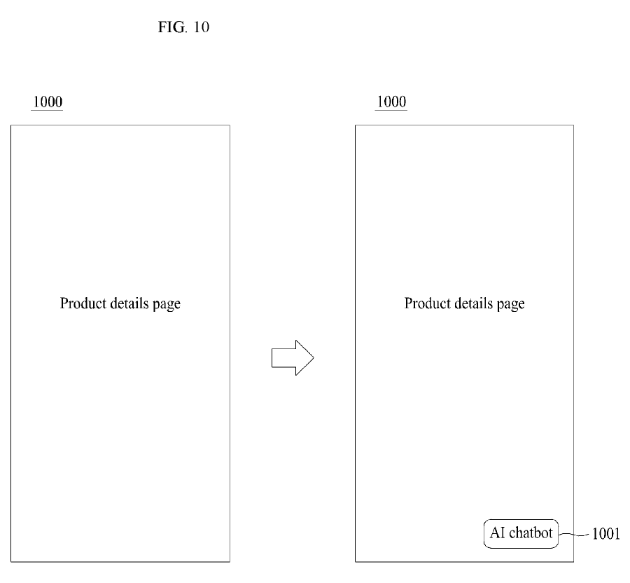

FIGS. 9 and 10 illustrate examples of utilizing a beauty counselor chatbot service according to an example embodiment.

The example embodiments may utilize the beauty counselor chatbot service for search results in conjunction with search environments of various platforms.

Referring to FIG. 9, the processor 120 may provide an answer 901 of the AI chatbot through the beauty counselor chatbot service as search results for a search term entered by the user on a search screen 900. Here, the search term may apply any types of queries (text, image, voice, etc.) that the user requests for search, including a search term entered as a text type, an image-based search term, and a voice recognition-based search term.

For example, in preparation for a case in which the search engine fails to provide search results corresponding to a user search request, the answer 901 of the AI chatbot may be provided as the search results using the beauty counselor chatbot service when there are no search results.

It is possible to respond to a natural language inquiry, an inquiry about an event, an inquiry about a product of another company, typos in a product name or a brand name, and various search terms of the user, and also possible to induce the user to access through conversation with the AI chatbot even in a search environment.

Also, the example embodiments may utilize the beauty counselor chatbot service on a product details page of the online beauty shopping mall.

Referring to FIG. 10, the processor 120 may support conversation with the AI chatbot through the beauty counselor chatbot service for a user who is browsing a corresponding product and considers purchasing the product on a product details page 1000.

For example, an 'AI chatbot' button 1001 to access the beauty counselor chatbot service may be activated for a user who enters a predetermined menu button (e.g., 'more' button to open the entire product information page) or a user who stays on the product details page 1000 for a predetermined period of time or more.

Here, the AI chatbot may provide an answer to a question of the user in relation to a corresponding product on the product details page 1000 and may provide a summary of product information within the product details page 1000.

In addition to the product details page 1000 of the online beauty shopping mall, the beauty counselor chatbot service may also be utilized for a promotion within the shopping mall. For example, the 'AI chatbot' button 1001 to access the beauty counselor chatbot service may be activated for a user who stays on a promotion page for a predetermined period of time or more.

The AI chatbot linked to a promotion may provide a customized promotion by reflecting personalized data of the user. A user who is browsing products and considering purchasing from various promotion information may resolve the user's questions and may find a suitable promotion while conversing with the AI chatbot.

Also, the example embodiments may utilize the beauty counselor chatbot service as a shopping assistant of the online beauty shopping mall.

Through various journeys from product search to purchase in the online beauty shopping mall (e.g., skin diagnosis, live commerce, gift giving, etc.), the user may resolve the user's questions and may be provided with various beauty-related entertainment while conversing with the AI chatbot.

Also, the example embodiments may utilize the beauty counselor chatbot service for promotions or answers to brand/channel inquiries through an external channel (e.g., KakaoTalk channel, etc.) related to the online beauty shopping mall.

For example, personalized promotion information and an answer to a brand/channel inquiry may be provided to a user who accesses a channel using an official account of the online beauty shopping mall among channels of KakaoTalk, through conversation with the AI chatbot.

Also, the example embodiments may utilize the beauty counselor chatbot service for a link tree exposed on a channel related to the online beauty shopping mall or for content related to the online beauty shopping mall within a video platform.

For example, by exposing a link to the beauty counselor chatbot service in a link tree of the online beauty shopping mall or in a video of the online beauty shopping mall within YouTube, it is possible to support conversation with the AI chatbot and to provide new user experience for a user accessed through the link.

Also, the example embodiments may provide the beauty counselor chatbot service in an offline pop-up store or an offline commerce space related to the online beauty shopping mall.

For example, using a quick response (QR) code provided in an offline event space like docent, it is possible to provide various beauty-related entertainment, or to resolve questions about each product and to provide brand or product information.

As described above, according to example embodiments, it is possible to link an event message or a delivery information message to an AI-based beauty counselor chatbot service. Also, it is possible to expose the chatbot service to a user who clicks on the event message or the delivery information message and to induce the user to access.

In the case of the event message, basic introduction to an event or a promotion and an answer to a specific question may be provided through natural conversation with a chatbot. In particular, by emphasizing a personalized special benefit or a specific promotion of a customer's usual preferred brand, an increased participation rate and purchase conversion rate may be expected.

In the case of the delivery information message, it is possible to proactively respond to consumer complaints by verifying a delivery status through natural conversation with the chatbot, and to improve customer satisfaction by providing, as recommendation content, products that are good to use with a recently purchased product or beauty information that is good to utilize, and by providing additional recommendation and guidance on a utilization method to the customer.

By analyzing various inquiries from users connected through event notification or delivery information notification, it is possible to additionally analyze problems or needs and questions that the users experience and to use the same to improve the service.

The apparatuses described herein may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, computer storage medium or device, to provide instructions or data to the processing device or to be interpreted by the processing device. The software also may be distributed over network coupled computer systems so that the software is stored and executed in a distributed fashion. The software and data may be stored by one or more computer readable storage mediums.

The methods according to the example embodiments may be implemented in the form of program instructions that may be performed through various computer methods and may be recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tapes; optical media such as CD ROM and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A chatbot service linkage method of a computer device comprising at least one processor, the chatbot service linkage method comprising:
receiving, by the at least one processor, a user request through an external channel to which an event message or a delivery information message of a beauty shopping mall is exposed;
executing, by the at least one processor, a conversation screen with an artificial intelligence (AI) chatbot for a beauty counselor chatbot service in response to the user request; and
providing, by the at least one processor, information related to a message corresponding to a user access path through the conversation screen.

2. The chatbot service linkage method of claim 1, wherein the event message or the delivery information message exposed to the external channel includes a link to access the beauty counselor chatbot service, and
in response to a click on the event message or the delivery information message, the click is recognized as the user request to call the beauty counselor chatbot service.

3. The chatbot service linkage method of claim 1, wherein the providing comprises providing information related to the message through the conversation screen at a point in time of entering the conversation screen.

4. The chatbot service linkage method of claim 1, wherein the providing comprises providing, to a user who is accessed through the event message, introduction to a corresponding event and personalized recommendation content to the user, through the conversation screen.

5. The chatbot service linkage method of claim 1, wherein the providing comprises providing, to a user who is accessed through the delivery information message, a delivery status of a product being guided and personalized recommendation content to the user.

6. The chatbot service linkage method of claim 1, further comprising:
providing, by the at least one processor, an answer of the AI chatbot through the beauty counselor chatbot service as search results for a search term of one type among text, image, and voice input from a user in conjunction with a search engine.

7. The chatbot service linkage method of claim 1, further comprising:
activating, by the at least one processor, a button to access the beauty counselor chatbot service for a user who stays on a product details page or promotion page of the beauty shopping mall for a predetermined period of time or more.

8. A computer device comprising:
at least one processor configured to execute computer-readable instructions,
wherein the at least one processor is configured to process:
a process of receiving a user request through an external channel to which an event message or a delivery information message of a beauty shopping mall is exposed;
a process of executing a conversation screen with an artificial intelligence (AI) chatbot for a beauty counselor chatbot service in response to the user request; and
a process of providing information related to a message corresponding to a user access path through the conversation screen.
